(19) United States
(12) Patent Application Publication
(10) Pub. No.: US 2004/0121125 A1
(43) Pub. Date: Jun. 24, 2004

(54) Engineered flexure component

(75) Inventor: Michael Roman Hachkowski, Ridgefield, CT (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: GOODRICH CORPORATION

(21) Appl. No.: 10/323,460

(22) Filed: Dec. 18, 2002

(51) Int. Cl. B32B 3/30; B32B 3/28

(52) U.S. Cl. 428/167

(57) ABSTRACT

A bolt flange is provided with parallel grooves across its surface. One bolt flange surface has grooves that run in a vertical direction, while a second bolt flange surface has grooves that run in a horizontal direction, such that they are perpendicular to the grooves of the first bolt flange mating surface. The purpose of the grooves is to create a surface that consists of flexures. These flexures cause two effects to occur at the bolted interface. First, for a given clamping force, the resulting surface is greater because of the smaller contact area at the interface which in turn increases the friction force. Second, the flexures are sufficiently flexible enough to bend and not slide as the two interface surfaces move relative to each other. The flexure points may different configurations, i.e. squares, circles, triangles, or other geometric shapes. The grooving of the surfaces allows a designer of optical instruments to be capable of determining the stiffness of the resulting flexure as well as control the percentages of forces that are transferred across an interface through friction as compared with elastic bending. The flexured interface also allows the designer to invoke load path management design rules. In summary, load path management is a process by which a designer can control the effect of friction by not effecting the frictional mechanisms, but by changing the elastic stiffness that surrounds the frictional element. Placing grooves in the interface mating surfaces enables a designer to model the interface stiffness as a series of bending beams, which in turn allows the designer to explicitly model the percentage of force that acts through friction.

### BACKGROUND OF THE INVENTION

1. Field of the Invention

This invention relates to an engineered flexure component used at the bolted interfaces of precision optical instruments.

2. Description of the Prior Art

For precision structures, such as telescopes, it is important to understand the sources of mechanical hysteresis, which is defined as the dependence of the strain of a material not only on the instantaneous value of the stress, but also on the previous history of the stress. It is known that whenever two structural elements are bolted together, friction exists at the bolted interface. Bolted interfaces are a source of both damping and instability. Friction may be the cause of energy dissipation as the two surfaces slide past one another as well as cause the two mating surfaces to slide and stop in a new position relative to each other. At present, interface designers cannot explicitly control the percentages of forces that act across an interface through friction. Currently, many optic mounts for precision optical instruments are bolted directly to an optical bench. In a high vibrational environment, the optic mounts tend to react to external forces and reposition themselves, thus causing the optical instrument to shift their position. Given the foregoing, there is a need for an engineered flexure component that is sufficiently flexible enough to bend and not slide as the mating surfaces of the bolted interface move relative to each other.

### SUMMARY OF THE INVENTION

A bolt flange is provided with parallel grooves across its surface. One bolt flange surface has grooves that run in a vertical direction, while a second bolt flange surface has grooves that run in a horizontal direction, such that they are perpendicular to the grooves of the first bolt flange mating surface. The purpose of the grooves is to create a surface that consists of flexures. These flexures cause two effects to occur at the bolted interface. First, for a given clamping force, the resulting surface pressure is greater because of the smaller contact area at the interface which in turn increases the friction force. Second, the flexures are sufficiently flexible enough to bend and not slide as the two interface surfaces move relative to each other. The flexure points may different configurations, i.e. squares, circles, triangles, or other geometric shapes. The grooving of the surfaces allows a designer of optical instruments to be capable of determining the stiffness of the resulting flexure as well as control the percentages of forces that are transferred across an interface through friction as compared with elastic bending. The flexured interface also allows the designer to invoke load path management design rules. In summary, load path management is a process by which a designer can control the effect of friction by not effecting the frictional mechanisms, but by changing the elastic stiffness that surrounds the frictional element. Placing grooves in the interface mating surfaces enables a designer to model the interface stiffness as a series of bending beams, which in turn allows the designer to explicitly model the percentage of force that acts through friction.

### BRIEF DESCRIPTION OF THE DRAWINGS

FIG. 1 is a perspective view of the engineered flexure component of the present invention;

FIG. 2 is a perspective view of an alternative embodiment to the engineered flexure component of FIG. 1;

FIG. 3 is an exploded view of a flexured assembly utilizing the embodiment shown in FIG. 1;

FIG. 4 is an exploded view of a flexured assembly utilizing the alternative embodiment shown in FIG. 2;

FIG. 5 is a model showing the force transfer in both the conservative and non-conservative load paths that may exist at the interface of a flexured assembly and

FIG. 6 is an illustration of the load paths that exist across the interface of a flexured assembly.

### DETAILED DESCRIPTION OF THE DRAWINGS

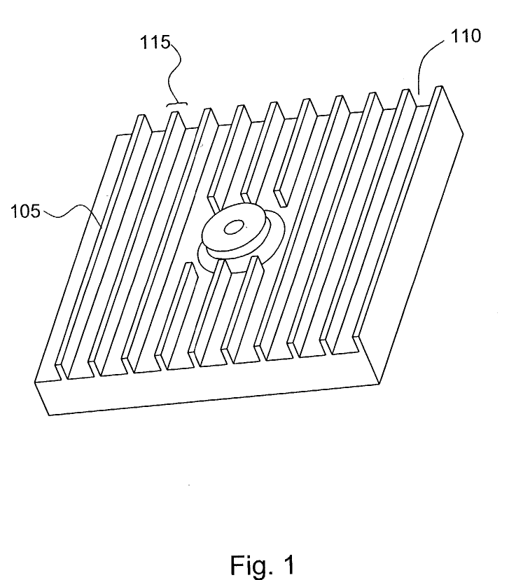

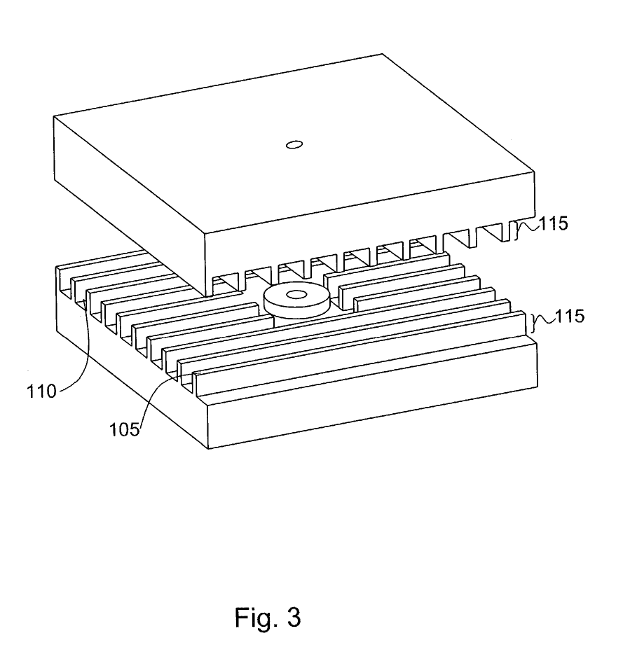

Referring to the drawings, and in particular, FIG. 1, there is provided a bolt flange 10 having a front surface 105. Bolt flange 10 is provided with parallel grooves 110 which transverse front surface 105. As shown in FIG. 1, grooves 110 transverse front surface 105 in a vertical direction. As shown in FIG. 3, front surface 105 of a second bolt flange has grooves which transverse front surface 105 in a horizontal direction, such that they are perpendicular to grooves 110 of the first bolt flange front surface 105 when the first and second bolt flanges are bolted together creating an interface.

The purpose of grooves 110 is to create a flexure 115. Flexures 115 cause two effects to occur at a bolted interface. First, for a given clamping force, the resulting surface pressure is greater because of the smaller contact area at the interface which in turn increases the coulombic friction force. Second, flexures 115 provide additional flexibility such that the percentage of force transmitted across the interface is reduced. The width and height of flexures 115 is determined by the flexure bending stiffness, flexure axial stiffness, flexure tortional stiffness, flexure buckling limit and load path management design rules.

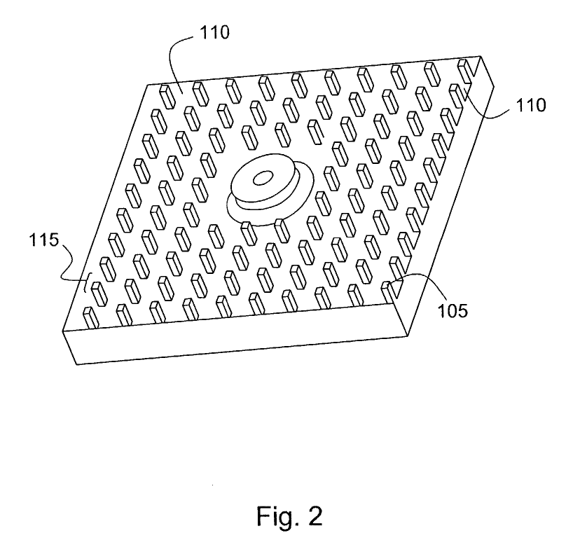

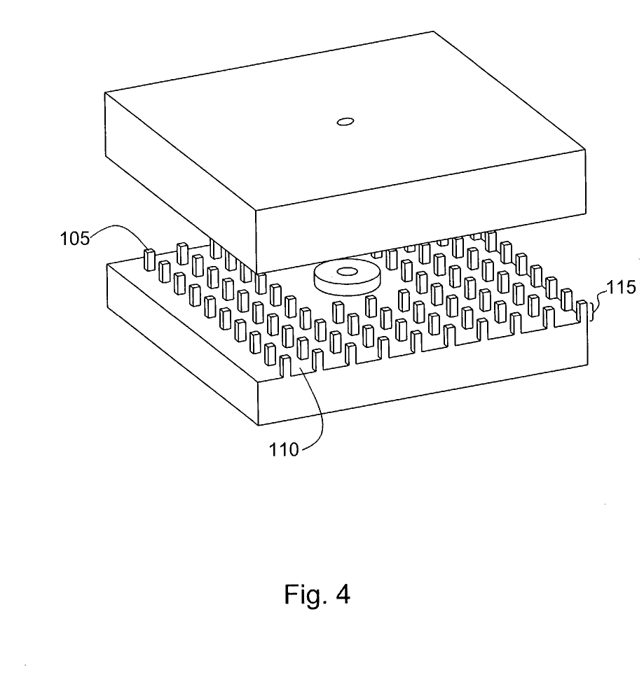

FIG. 2 is an alternative embodiment in which grooves 110 transverse front surface 105 in both the vertical and horizontal directions, creating a cross-hatched appearance. As shown in FIG. 4, this embodiment is used when the bolt flange comes into with a flat, smooth surface. In other alternative embodiments, the flexure points may have different configurations, i.e. squares, circles, triangles, or other geometric shapes.

Load path management theory states that it is possible to reduce or tailor the effect of interface friction by effecting the elastic mechanisms that surround the friction element. Due to the dependency that hysteresis has on the relative magnitudes of stiffness at an interface, load path management states that it is possible to reduce the dissipation due to friction at an interface not by affecting the friction mechanism, but by changing the relative magnitudes of stiffness. This can be achieved by changing the design of the interface to increase the percentage of load transferred through internal elastic mechanisms.

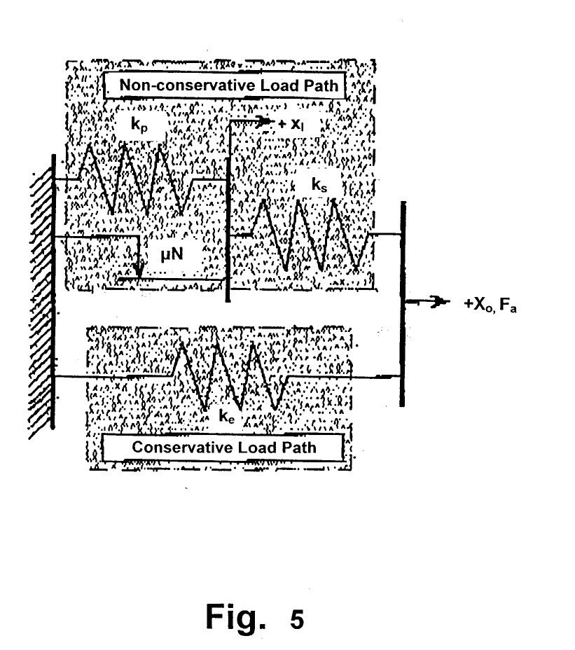

When force is transferred across a physical interface, normal and tangential stresses and local deformations occur at the interface. When load transfer occurs through normal stresses at the interface, the load path is elastic, i.e. conservative. When load transfer occurs through shear stress at the interface, friction must be present and thus slippage can occur. When load transfer occurs across friction interfaces, it is considered non-conservative. This force transfer is shown in the interface model of FIG. 5. This model is comprised of two distinct segments and is a representation of the conservative and non-conservative load paths that may exist at an interface. The conservative segment of the model represents an interface design for which there are only elastic mechanisms (other than material hysteresis) in the load path. The non-conservative segment of the model represents a combination of elastic and friction mechanisms that exist in a non-conservative load path. The hysteretic mechanism of the interface is represented by a Coulombic friction mechanism which is in parallel with a linear spring element (kₚ) as well as in series with another linear spring element (kₛ). A Coulombic friction mechanism was chosen because it represents the hysteretic mechanics that exist at an interface. A linear, elastic mechanism (kₑ) in parallel with the non-conservative load path represents the conservative load path at an interface. The analytical model of FIG. 4 represents such an interface. This interface model illustrates how an externally applied load (Fₐ) may be divided into elastic (i.e. normal) and inelastic (i.e. tangential) load path components for load transfer across the interface. The kₑ elastic element of the model represents the elastic behavior of the body from the application of the external load to normal stress at the interface. The kₛ elastic mechanism of the model represents the elastic behavior of the body from the application of the external load to shear stress at the interface. Load transfer across the interface is represented by an elastic mechanism (kₚ) in parallel with the friction mechanism ΦN. The elastic mechanism kₚ represents the portion of the shear load that is transferred across an interface elastically, i.e. regions within the contact area where slip does not occur. The friction mechanism represents the portion of the shear load that is transferred across an interface inelastically, i.e. regions within the contact area where slip does occur.

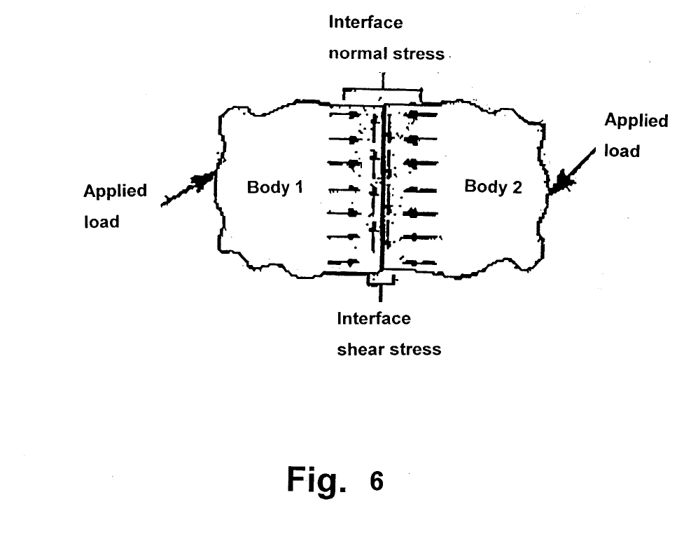

Using a loss factor analysis, it is shown that if displacement-dependent friction exists in the model shown in FIG. 6, it is possible to reduce the friction effect by changing the relative magnitudes of internal stiffness such that an ever increasing percentage of the force is transferred through internal elastic mechanisms, i.e. load path management. The engineered flexure component of the present invention involves changing the value of kₛ, the elastic spring constant associated with the elastic behavior of the body from the application of the external load to the shear stress at the interface. Reducing the spring stiffness kₛ reduces the percentage of force that acts through elastic mechanisms. This changing of the local interface between the mating surfaces of structural elements allows the mating surfaces to return to their original position because the flexure points bend, but do not slide with respect to each other.

The present invention having been described with particular reference to the preferred forms thereof, it will be obvious that various changes and modifications may be made without departing from the spirit and scope of the invention as defined in the appended claims.

What is claimed is:

1. An engineered flexure component comprising first and second adjacent surfaces, wherein said first surface comprises a plurality of grooves which transverse said first surface, said grooves creating a plurality of flexures having a predetermined height and width, wherein said flexures are in contact with said second surface.

2. The engineered flexure component of claim 1, wherein said plurality of grooves are parallel to each other.

3. The engineered flexure component of claim 1, wherein said plurality of grooves completely transverse said first surface.

4. The engineered flexure component of claim 1, wherein said plurality of grooves transverse said first surface in a vertical direction.

5. The engineered flexure component of claim 1, wherein said plurality of grooves transverse said first surface in a horizontal direction.

6. The engineered flexure component of claim 1, wherein said first surface has a first set of grooves that transverse said first surface in a vertical direction and a second set of grooves that transverse said first surface in a horizontal direction, said first set of grooves being perpendicular to said second set of grooves.

7. The engineered flexure component of claim 1, wherein said height and width of said flexures is determined by a combination of flexure bending stiffness, flexure axial stiffness, flexure tortional stiffness, flexure buckling limit and load path management design rules.

8. The engineered flexure component of claim 1, wherein said flexures have a height ranging from about ¼ inch to about 1 inch.

9. The engineered flexure component of claim 1, wherein said flexures have a width ranging from about ⅛ inch to about 1 inch.

10. The engineered flexure component of claim 1, wherein said flexures are geometric in shape.

11. The engineered flexure component of claim 1, wherein an interface is created between said flexures of said first surface and said second surface.

12. A method of contacting a first surface to a second surface, which comprises:
(a) grooving said first surface with a first set of grooves to create a series of flexures;
(b) grooving said second surface with a second set of grooves to create a series of flexures;
(c) mating said first surface with said second surface so that said first set of grooves are perpendicular to said second set of grooves; and
(d) creating an interface with an increased surface pressure and reduced friction.
